(19) United States
(12) Patent Application Publication
(10) Pub. No.: US 2002/0139234 A1
(43) Pub. Date: Oct. 3, 2002

(54) Automatic cutting device for boiler tube water wall

(76) Inventors: Yasuyuki Inouye, Tokyo (JP); Hiroshi Imaizumi, Tokyo (JP); Morihide Yonaha, Tokyo (JP); Kenichi Yatsuda, Tokyo (JP)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/918,282

(22) Filed: Jul. 30, 2001

(30) Foreign Application Priority Data
Apr. 3, 2001 (JP) 104263

(51) Int. Cl. B26D 5/00

(52) U.S. Cl. 83/745; 83/743

(57) ABSTRACT

In an automatic cutting device for a boiler tube water wall, cost can be reduced significantly by exactly cutting position in a boiler tube water wall, and at the same time by operating four automatic cutting devices for a boiler tube water wall by one operator by making the cutting work full automatic, in order to decrease the manpower and labor cost and to significantly reduce the term of work. The automatic cutting device includes: an abrasive cutting wheel; a slide shaft provided so as to be rotatable through 90° with respect to a rail; a first motor for rotating the abrasive cutting wheel at a high speed; a second motor for sliding the slide shaft in the direction perpendicular to the rail; a third motor for moving a carriage in the direction parallel with the rail; a first limit switch for detecting a position at which the cutting of the boiler tube water wall is completed; a relay for switching the flow of current from the second motor to the third motor; a second limit switch for determining the cut length of the boiler tube water wall; and a control circuit for changing the cutting speed by setting the rated current of the first motor.

### BACKGROUND OF THE INVENTION

1. Field of the Invention

The present invention relates to an automatic cutting device for a boiler tube water wall (panel). Description of the Prior Art Conventionally, a boiler combustion chamber is manufactured of a boiler tube water wall, so that the boiler combustion chamber is always worn and corroded, with the result that the thickness of a boiler tube of the boiler tube water wall decreases. If the boiler tube water wall becomes incapable of withstanding a pressure, it is partially cut and replaced with a new boiler tube water wall.

The conventional cutting method has been to apply gas cutting, plasma cutting or to use a grinder.

The above-described conventional cutting method not only greatly degrades the work environment but also provides very low productivity.

The reason for this is that since it is difficult to secure an exact cutting position, cutting operation is performed at a position 5 to 10 mm shorter than the exact position, and the end faces of the boiler tubes are finished by machining one after another to joint design for weld.

Despite the fact that the number of boiler tubes is huge, and therefore the work for boiler tubes occupies most of the term of boiler repair, it is difficult by all possible means to exactly cut the boiler tube water wall by the conventional cutting method, and thereby the boiler tube water wall has to be cut at the position shifted by 5 to 10 mm. As a result, there arises a problem of causing low productivity and a high cost because many workers are required and thus a high labor cost and working time is required.

### BRIEF SUMMARY OF THE INVENTION

Object of the Invention

Accordingly, an object of the present invention is to significantly reduce cost by keeping the shift of cutting position to 2 mm or smaller to exactly cut a boiler tube water wall, and at the same time by operating four automatic cutting devices for a boiler tube water wall by one operator by making the cutting work full automatic, in order to decrease the manpower and labor cost and to significantly reduce the term of work.

Summary of the Invention

To attain the above object, the automatic cutting device for a boiler tube water wall in accordance with the present invention includes: an abrasive cutting wheel; a slide shaft provided so as to be rotatable through 90° with respect to a rail; a first motor for rotating the abrasive cutting wheel at a high speed rotation (2500˜3500 rpm); a second motor for sliding the slide shaft in the direction perpendicular to the rail; a third motor for moving a carriage in the direction parallel with the rail; a first limit switch for detecting a position at which the cutting of the boiler tube water wall is completed; a relay for switching the flow of current from the second motor to the third motor; a second limit switch for determining the cut length of the boiler tube water wall; and a control circuit for changing the cutting speed by setting the rated current of the first motor.

Also, the control circuit preferably includes a current detector, an operational amplifier, and a driver.

Further, the abrasive cutting wheel and a storage section for the first motor can preferably be arranged vertically by rotating the slide shaft through 90° with respect to the rail.

### BRIEF DESCRIPTION OF THE DRAWINGS

FIG. 1 is a view showing an automatic cutting device for a boiler tube water wall, in which a rail is fixed onto a diaphragm surface by temporary tack welding so as to be parallel with the boiler tube water wall;

FIG. 2 is a view showing a state of a change of a portion cut by an abrasive cutting wheel;

FIG. 3 is a view showing a state of a boiler tube water wall having been cut and a state of cutting into a slit form;

FIG. 4 is a view showing a cross section of the boiler tube water wall;

FIG. 5 is a view showing horizontal cutting work for the boiler tube water wall; and

FIG. 6 is a view showing vertical slit-form cutting work for the boiler tube water wall.

### DETAILED DESCRIPTION OF THE PREFERRED EMBODIMENTS

An example of an embodiment of the present invention will now be described with reference to the accompanying drawings.

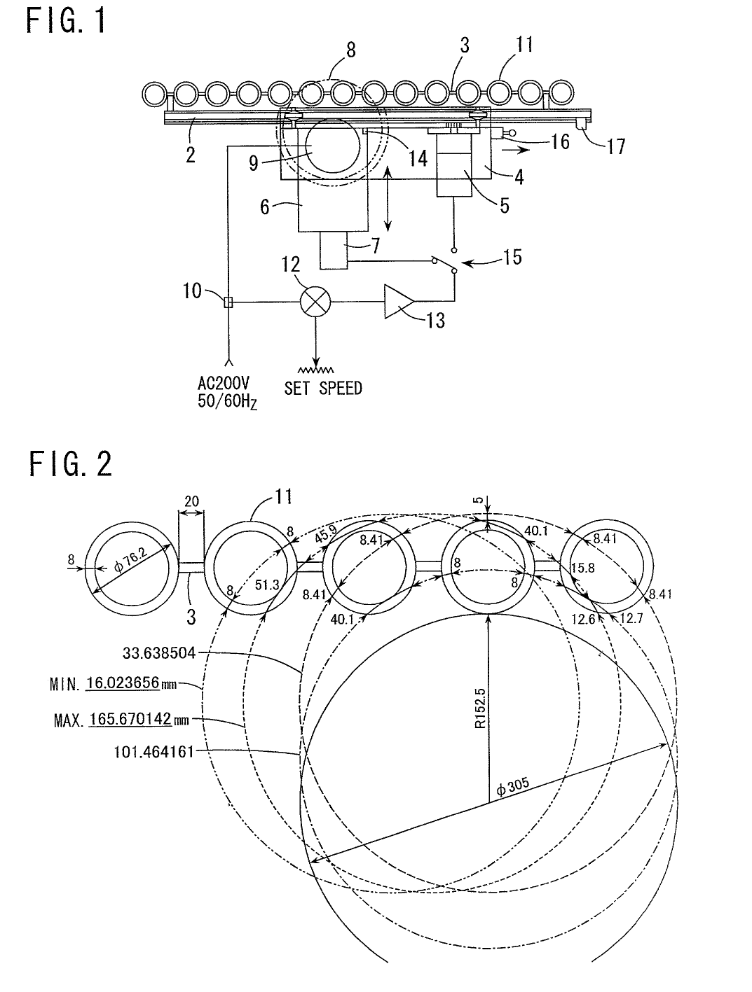

FIG. 1 is a view showing an automatic cutting device for a boiler tube water wall, in which a rail is fixed onto a diaphragm surface by temporary tack welding so as to be parallel with the boiler tube water wall.

A rail 2 is fixed onto the surface of a diaphragm 3 by temporary tack welding so as to be parallel with the boiler tube water wall 1, and a carriage 4 that runs on the rail 2 is mounted thereon. The carriage 4 is driven by a third motor (DC servomotor) 5.

The carriage 4 has a slide shaft 6 extending in the direction perpendicular to the rail 2. The slide shaft 6 is moved in the direction perpendicular to the rail 2, that is, in the longitudinal direction as indicated by the arrow mark by using a second motor (DC servomotor) 7.

A slide portion of the slide shaft 6 is provided with a first motor 9 for rotating an abrasive cutting wheel 8 at a high speed rotation (2500˜3500 rpm).

Horizontal cutting work will be performed as described below. First, the rated current value of the first motor 9 for rotating the abrasive cutting wheel 8 at a high speed is set. Next, the first motor 9 is rotated to move the slide shaft 6. Thus, the abrasive cutting wheel 8 approaches and comes into contact with the boiler tube water wall 1, by which the cutting work is started.

As shown in FIG. 4, the boiler tube water wall is not simply made of boiler tubes 11, but has diaphragms 3 formed of a flat plate, which are welded to the boiler tubes 11. Therefore, a portion cut by the abrasive cutting wheel 8 changes always. A state of the change is shown in FIG. 2. From FIG. 2, it is found that the contact length changes from 16 mm at minimum to 165.6 mm at maximum by a factor of about ten, since the abrasive cutting wheel 8 cuts the boiler tube Accordingly, when the slide shaft 6 is moved at a constant speed, the load current of the first motor 9 also changes by about ten times, so that the first motor 9 is burned.

Thereupon, in the present invention, as shown in FIG. 1, a current is always measured by using a current detector 10 for detecting a load current of the first motor 9, and a difference between the measured current and the rated current set value of the first motor 9 is measured by using an operational amplifier 12 for reading the difference. Thereby, the speed of the second motor 7 is automatically corrected by using a driver 13 to automatically perform cutting.

This means a current of first motor 9 keeps constant and, as the result, the speed of the second motor 7 changes depending on the contact length of cutting wheel 8 with boiler tube water wall.

After the slide shaft 6 has moved to a first limit switch 14 for detecting a position at which the cutting of the boiler tube water wall 1 is completed, a relay 15 is switched, by which the speed of the third motor 5 is controlled automatically in the same principle as described above so that the carriage 4 moves in the horizontal direction (direction parallel with the rail) to cut the boiler tube water wall 1 continuously. The cut surface of the boiler tube water wall 1 is as shown in FIG. 4.

The cutting operation is performed in a full automatic mode until a second limit switch 16 for determining the cut length of the boiler tube water wall 1 is tripped, that is, until the second limit switch 16 comes into contact with a dog 17. When the cutting operation is completed, the operator can be informed of the completion of work by a flash lamp (not shown) going on and off.

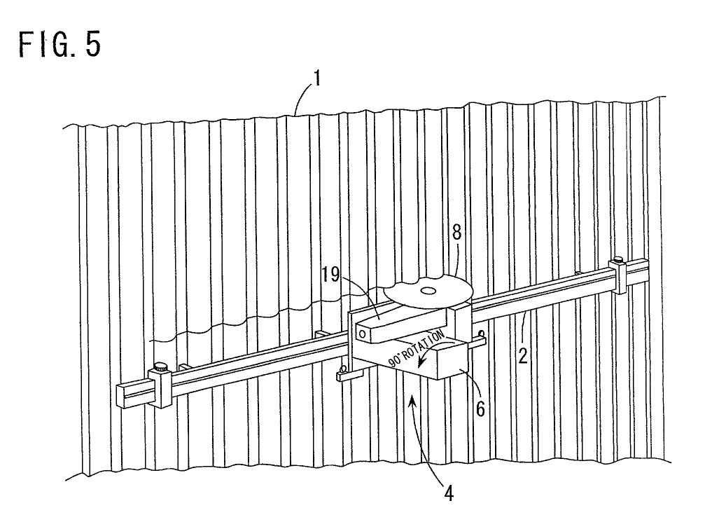

The above-described work is horizontal cutting work as shown in FIG. 5.

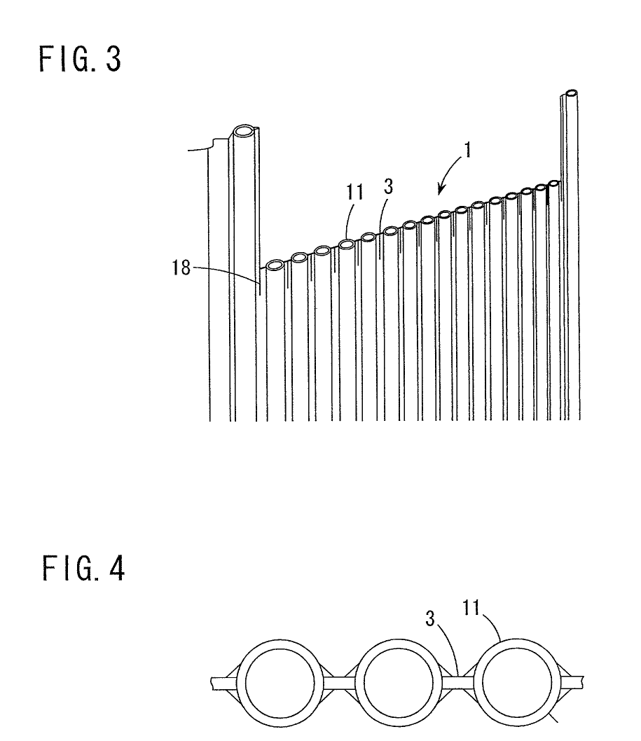

After the boiler tube water wall has been cut out into a rectangular shape as shown in FIG. 3, edge preparation on the end faces of the boiler tubes 11 is accomplished. Thereafter, a newly manufactured boiler tube water wall is inserted in the cut portion, and the end faces of the boiler tube water walls are joined to each other by welding.

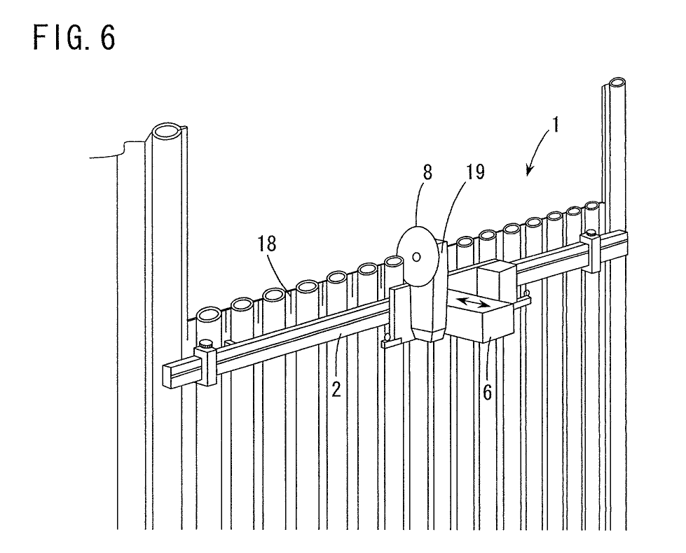

It is difficult to align the axes of upper and lower boiler tubes 11 with each other in whole. Therefore, it is also necessary that as shown in FIG. 6, a central portion of the diaphragm 3 be cut in a form of a slit 18 with a length of at least 150 mm from the end face to facilitate the alignment of the boiler tubes 11.

The above-described slit-form cutting operation in diaphragm using the automatic cutting device for a boiler tube water wall in accordance with the present invention will be performed as described below. The slide shaft 6 is rotated through 90° with respect to the rail 2 as shown in FIG. 5, and thereby the abrasive cutting wheel 8 and a storage section 19 for the first motor 9 are rotated through 90° with respect to the rail 2, that is, to the vertical position as shown in FIG. 6. Then, the slide shaft 6 is moved in the longitudinal direction as indicated by the arrow mark by using the second motor 7. Thereby, the slits 18 in the boiler tube water wall 1 are cut.

The abrasive cutting wheel 8, which has a diameter of about 350 mm, can cut slits about 150 mm long when the wheel 8 advances through a distance of about 40 to 50 mm in diaphragm.

Since the cutting device for a boiler tube water wall in accordance with the present invention has the above-described construction, cost can be reduced significantly by exactly cutting a boiler tube water wall, and at the same time by operating four automatic cutting devices for a boiler tube water wall by one operator by making the cutting work full automatic, in order to decrease the manpower and labor cost and to significantly reduce the term of work.

What is claimed is:

1. An automatic cutting device for a boiler tube water wall, comprising:
an abrasive cutting wheel;
a slide shaft provided so as to be rotatable through 90° with respect to a rail;
a first motor for rotating said abrasive cutting wheel at a high speed;
a second motor for sliding said slide shaft in the direction perpendicular to said rail;
a third motor for moving a carriage in the direction parallel with said rail;
a first limit switch for detecting a position at which the cutting of the boiler tube water wall is completed;
a relay for switching the flow of current from said second motor to said third motor;
a second limit switch for determining the cut length of the boiler tube water wall; and
a control circuit for changing the cutting speed by setting the rated current of said first motor.

2. The automatic cutting device for a boiler tube water wall according to claim 1, wherein said control circuit includes a current detector, an operational amplifier, and a driver.

3. The automatic cutting device for a boiler tube water wall according to claim 1, wherein said abrasive cutting wheel and a storage section for said first motor can be arranged vertically by rotating said slide shaft through 90° with respect to said rail for slit cutting in diaphragm.
